(19) United States
(12) Patent Application Publication
(10) Pub. No.: US 2021/0364128 A1
(43) Pub. Date: Nov. 25, 2021

(54) REFUELLING METHOD AND DEVICE FOR SUPPLYING LIQUEFIED GASES AND THE LIKE

(71) Applicant: GAS AND HEAT S.P.A., Livorno (IT)

(72) Inventor: Federico EVANGELISTI, LIVORNO (IT)

(73) Assignee: GAS AND HEAT S.P.A., Livorno (IT)

(21) Appl. No.: 16/651,894

(22) PCT Filed: Sep. 26, 2018
(86) PCT No.: PCT/IB2018/057431

§ 371 Date: Mar. 27, 2020

(30) Foreign Application Priority Data
Sep. 29, 2017 (IT) 102017000109469

(51) Int. Cl. F17C 5/02

(52) U.S. Cl. CPC F17C 5/02; F17C 2221/033; F17C 2205/0338; F17C 2265/037; F17C 2270/0105; F17C 2227/0135; F17C 2250/0434; F17C 2223/0161

(57) ABSTRACT

A refuelling device for supplying liquefied gas is provided, including a feed system adapted to place each reservoir in fluidic through connection with a tank and including withdrawal ducts for withdrawing the liquefied gas from the reservoirs; an inlet duct for introducing the liquefied gas into the tank; a collection manifold for conveying the withdrawal ducts into the inlet duct; a pump adapted to move the liquefied gas in the feed system; and a pressure gauge to measure the inlet pressure of the liquefied gas in the pump; and a valve adapted to regulate the flow in the inlet duct according to the inlet pressure.

The present invention relates to a refuelling method and device for supplying liquefied gases and the like of the type as recited in the preamble of the independent claims.

In particular, the invention relates to a method and device for supplying LNG, i.e. liquefied natural gas. It is suitable to allow the refuelling of a vehicle such as preferably a ship.

As is well known, ship refuelling requires a tanker truck filled with LNG to be positioned on a quay near the ship to be refuelled; the connection of the reservoir to the tank of the ship and then the LNG feeding by a pump from the reservoir into the tank.

The prior art described above has some notable drawbacks.

A first important drawback lies in the fact that several reservoirs have to be used to fill a ship. In detail, this filling process involves the sequential use of reservoirs in order to avoid problems related to the flow of LNG and in particular to the pump operation control.

Therefore, the process is slow and particularly expensive.

Another important drawback is that, due to the tank emptying (with a consequent risk of pump cavitation) and/or the tank filling (with an increased duration of the operation), the conditions of the fluids in the reservoir and/or in the tank evolve constantly, thus making the pump regulation process very complex.

To overcome these problems, the reservoirs are provided with a vaporizer that draws LNG from the reservoir, vaporizes it and introduces it into the reservoir, by counterbalancing the pressure lowering.

However, the amount of steam produced by the vaporizer does not allow to rebalance the pressure loss due to the emptying of the reservoir, and it does not overcome this problem definitively.

In addition, the amount of vaporized LNG is not introduced into the tank and is therefore lost, which leads to increasing costs.

It should be noted that the drawback mentioned above is amplified by the operator's difficulties in managing the different pressures in the reservoirs.

In this context, the technical task underlying the present invention is to develop a refuelling method and device for supplying liquefied gases, able to substantially overcome at least some of the drawbacks mentioned above.

Within the sphere of said technical task one important aim of the invention is to provide a refuelling method and device for supplying liquefied gases, that is simple to control, fast and inexpensive.

The technical task and the specified aims are achieved with a refuelling method and device for supplying liquefied gases as claimed in the appended independent claims. Examples of preferred embodiments are described in the dependent claims.

Preferred embodiments are set forth in the dependent claims.

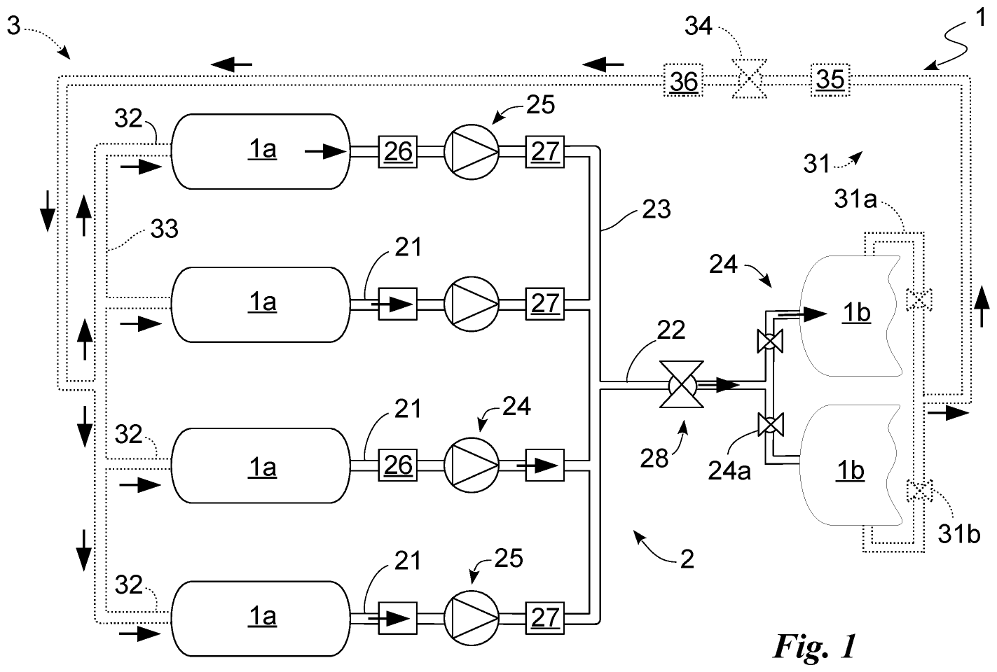

The features and advantages of the invention will be apparent from the following detailed description of preferred embodiments thereof, with reference to FIG. 1 showing a diagram of the device for supplying liquefied gases according to the invention.

Herein, the measures, values, shapes and geometric references (such as perpendicularity and parallelism), when used with words like “about” or other similar terms such as “approximately” or “substantially”, are to be understood as except for measurement errors or inaccuracies due to production and/or manufacturing errors and, above all, except for a slight divergence from the value, measure, shape or geometric reference which it is associated with. For example, these terms, if associated with a value, preferably indicate a divergence of not more than 10% from said value.

Furthermore, when used, terms such as “first”, “second”, “higher”, “lower”, “main” and “secondary” do not necessarily identify an order, a priority relationship or a relative position, but can simply be used to distinguish more clearly the different components from each other.

Unless otherwise indicated, the measurements and data provided in this document are to be considered using International Standard Atmosphere ICAO (ISO 2633). Unless otherwise specified, as is apparent from the following discussion, terms such as “treatment”, “data processing”, “determination”, “calculation”, or the like, are understood to refer to the action and/or processes of a computer or similar electronic computing device which manipulates and/or transforms data represented as physical, such as electronic sizes of registers of a computer system and/or memories, into other data similarly represented as physical quantities in computer systems, registers or other storage, transmission or information display devices.

With reference to the FIGURES, reference numeral 1 globally denotes the device for supplying liquefied gases according to the invention.

The term liquefied gases identifies all liquids obtained by liquefaction of a gas, suitably combustible, so as to reduce, even by 600 times, the specific volume thereof, compared to standard conditions. In order to keep the gas in the liquid phase, the liquefied gas is stored at a liquefaction temperature (usually −160° C.) which is lower than the ambient temperature (the temperature at which the gas is in the gas phase).

The liquefied gas is preferably LNG.

The refuelling device 1 is adapted to use at least one refuelling reservoir 1a containing the liquefied gas to refuel one or more tanks 1b, usually one or two tanks 1b.

Preferably the refuelling device 1 is suitable to use more than one reservoirs 1a, in particular working in parallel, to refuel simultaneously one or more tanks 1b (for example one or two).

Preferably the reservoirs 1a are between three and seven, more preferably four. One or more reservoirs 1a can be static, i.e. integrally fastened to the ground; and/or mobile and, for example, moveable by truck.

The tank 1b can be the tank of a vehicle and in particular of a ship.

If several tanks 1b are connected to the device 1, the tanks 1b may be part of a single vehicle, and in particular of a single ship, or of several vehicles, and in particular of several ships.

The refuelling device 1 comprises a fluid feed system 2 from the at least one reservoir 1a to the at least one tank 1b; and preferably a pressurisation system 3 of the one or more reservoirs 1a.

The feed system 2 is adapted to place at least a reservoir 1a in fluidic through connection with the at least one tank 1b thereby allowing the liquefied gas to pass from said at least one reservoir 1a to said at least one tank 1b.

Preferably, the feed system 2 is adapted to place a plurality of reservoirs 1a, appropriately four, in fluidic through connection with the at least one tank 1b at the same time so that the liquefied gas passes simultaneously from each reservoir 1a to one or more tanks 1b.

The feed system 2 may comprise, for each reservoir 1a, a withdrawal duct 21 for withdrawing liquefied gas from said reservoir 1a.

The feed system 2 may comprise, for each reservoir 1b, an inlet duct 22, preferably only one, of the liquefied gas to the reservoir 1b.

In the case of one withdrawal duct 21 and one inlet duct 22, the ducts 21 and 22 are in direct fluidic through connection so that the liquefied gas passes from the withdrawal duct 21 directly to the inlet duct 22. In this case, the ducts 21 and 22 can identify only one duct.

In the case of several withdrawal ducts 21 (i.e. several reservoirs 1a), the feed system 2 may comprise a collection manifold 23 placing the withdrawal ducts 21 simultaneously in fluidic through connection with the inlet duct 22, thus placing the reservoirs 1a in parallel.

The collection manifold 23 is then adapted to convey the liquefied gas exiting from the withdrawal ducts 21 into the inlet duct 22. It is interposed between the ducts 21 and 22.

In the case of several tanks 1b, the feed system 2 may comprise a distributor 24 placing the inlet duct 22 simultaneously in fluidic through connection with the tanks 1b.

The distributor 24 can be provided with a flow regulating device 24a for each tank 1b.

The flow regulating device 24a is adapted to regulate the flow entering a tank 1b, for example, by allowing the device 1 to refuel or not the tank 1b connected to it. The flow regulating device 24a can be external to the device 1 and part of a tank 1b.

The feed system 2 may comprise at least one pump 25 adapted to move the liquefied gas in the feed system 2 and, therefore, from the at least one reservoir 1a to the tank 1b.

In the case of several reservoirs 1a the at least one pump 25 is adapted to simultaneously control the withdrawal of liquefied gas from all reservoirs 1a which are then emptied in parallel.

In detail, the feed system 2 may comprise one pump 25 suitably integrated in the inlet duct 22. It is suitable for withdrawing the liquefied gas simultaneously from the reservoirs 1a as it is located downstream of the manifold 23.

In this document, the terms “downstream” and “upstream” refer to the direction of advancement of the liquefied gas in the feed system 2 and of the filling gas (described below) in the pressurisation system 3.

Alternatively, the feed system 2 may comprise a plurality of pumps 25, one for each withdrawal duct 21, such pumps being suitable to operate in parallel so as to withdraw the liquefied gas simultaneously from the reservoirs 1a.

Each pump 25 is integrated in the withdrawal duct 21.

Preferably the operating parameters of the pumps 25 are identical.

Since said pumps 25 are simultaneously in fluidic through connection with a single inlet duct 22, they define substantially the same outlet pressure. Each pump 525 mutually influences the output pressure (described below) of all other pumps 25.

Preferably the pumps 25 are the only pumps of the device 1.

The feed system 2 may comprise for each pump 25a pressure gauge 26 for the inlet pressure of the liquefied gas in the pump 25.

The pressure gauge 26 is upstream of the pump 25. It is adapted to be interposed between the pump 25 and the reservoir 1a.

It should be noted that, being measured upstream of the pump 25, the inlet pressure can substantially correspond to that of the reservoir 1a.

The pressure gauge 26 can be used to measure said inlet pressure of the liquefied gas in the inlet duct 22. It is integrated in the inlet duct 22 (in the case of a single pump 25).

Alternatively, the pressure gauge 26 can be adapted to measure the inlet pressure in the withdrawal duct 21. It is then integrated into the withdrawal duct 21. In particular, in the case of several pumps 25, the feed system 2 may comprise several gauges 26, one for each withdrawal duct 21.

The feed system 2 may comprise at least one pressure meter 27 for the outlet pressure of the liquefied gas exiting from at least one pump 25.

The pressure meter 27 is downstream of the pump 25. It is therefore suitable for interposing between the pump 25 and the tank 1b.

The feed system 2 may comprise only one pressure meter 27 adapted to measure the outlet pressure in the inlet duct 22. It is integrated in the inlet duct 22.

Alternatively, the feed system 2 may comprise several pressure meters 27. Each of them is adapted to measure said outlet pressure in a withdrawal duct 21 downstream of said pump 25 and then integrated in a withdrawal duct 21 (FIG. 1). The feed system 2 may comprise at least one regulating valve 28 to regulate, suitably automatically, the flow of liquefied gas in at least the inlet duct 22 according to the inlet and/or outlet pressure and preferably to their difference.

The regulating valve 28 is downstream of the pump 25 and preferably of the pressure meter 27.

The feed system 2 may comprise several regulating valves 28, each integrated in a withdrawal duct 21 and adapted to regulate the flow of liquefied gas in a withdrawal duct 21 and consequently in the collection manifold 23 and in the inlet duct 22.

Preferably, the feed system 2 comprises only one regulating valve 28 integrated in the inlet duct 22.

The regulating valve 28 is adapted to regulate the operation of pump 25, keeping it in the optimal operating range/curve.

In particular, it is adapted to adjust the flow downstream of the pump 25, thus maintaining a constant difference between the outlet and inlet pressure. In accordance with said difference between the outlet and inlet pressures, the regulating valve 28 provides operating parameters for the pump 25 so as to keep it within the optimal operating range.

Preferably the regulating valve 28 is adapted to adjust the operating parameters of the pumps 25 keeping them equal to each other.

In FIG. 1 the pressurization system 3 is shown—unlike the adduction system 2—with a dotted line to facilitate the distinction between the two systems 2 and 3.

The pressurisation system 3 is adapted to operate by counteracting the lowering of the pressure in the reservoir 1a due to the withdrawal of liquefied gas, preferably by keeping the pressure in the reservoir 1a almost constant during refuelling.

In particular, it is adapted to increase the pressure in one or more reservoirs 1a with a pressure lower than at least one tank 1b.

The pressurisation system 3 can be adapted to perform this function by introducing into the reservoir 1a a filling gas, suitably steam.

The pressurisation system 3 may comprise a return line 31 adapted to withdraw the filling gas, for example, from an external apparatus such as a cylinder/external circuit of natural gas or other filling gas, preferably an inert gas.

The pressurisation system 3 may comprise, for each reservoir 1a, a second duct 32 adapted to carry the filling gas from the return line 31 to a reservoir 1a.

The second duct 32 is adapted to be placed in fluidic through connection with a reservoir 1a.

In the case of several reservoirs 1a, the pressurisation system 3 is adapted to provide parameters for the reservoirs 1a which are almost equal to each other. In particular, it may comprise a connecting member 33 adapted to place the reservoirs 1a in reciprocal fluidic through connection so as to place said reservoirs under the same pressure.

Preferably, the pressurisation system 3 is adapted to equalise the pressures of the reservoirs 1a by introducing a filling gas into them. It can thus comprise a return line 31; several conduits 31 (one for each reservoir 1a), and a connecting member 33 interposed between the return line 31 and the duct 32 so that the return line 31 is in fluidic through connection simultaneously with all the ducts 32.

The pressurization system 3 may comprise a compressor upstream of the connection member 3 so as to place the member 33 and the ducts 32 under the same pressure.

Advantageously, the pressurization system 3 is devoid of compressors, i.e. it has a natural circulation. The passage of the filling gas from the at least one tank 1b to said one or more reservoirs 1a occurs through natural circulation and it is therefore controlled by the pressure drop of the reservoirs 1a during refuelling.

Preferably, the filling gas is the boil-off in at least one tank 1b (in this document the term boil-off identifies the portion of liquefied gas in the tank 1b which turned to the gaseous state) and the return line 31 is adapted to be placed in fluidic through connection with said at least one tank 1b.

The pressurisation system 3 is adapted to place in flidic through connection said at least one tank 1b with said at least one reservoir 1a.

As a result, the inlet and outlet pressures of the pump 25 can be reduced as much as possible and in particular adjusted keeping the pump in the optimal operating field/curve.

In the case of a single tank 1b the return line 31 can be identified as a duct.

In the case of several tanks 1b the return line 31 comprises a collection body 31a for the filling gas (the boil-off) exiting the tanks 1b.

The collection body 31a is adapted to convey and then introduce the filling gas from the tanks 1b into the duct 32 in the case of one reservoir 1a or into the connecting member 33 in the case of several reservoirs 1a.

In addition, in the case of several tanks 1b, the return line 31 may comprise, in addition to the collection body 31a, means of regulation 31b of the gas flow exiting each tank 1b.

The means of regulation 31b are therefore only adapted to control the passage of filling gas from the tank 1b to the reservoir 1a if the pressure in the tank 1b exceeds a predefined threshold and in particular the pressure in at least one reservoir 1a.

The means of regulation 31b may be external to device 1 and part of a tank 1b.

Each duct 32 may comprise at least one closing block (not shown in the FIGURE) adapted to measure the pressure in a duct 32 and selectively allow the fluid to pass to the reservoir 1a only if the pressure in that reservoir 1a is less than tank 1b.

A closing block may be external to the device 1 and part of a reservoir 1a.

To selectively control the flow of fluid from the at least one tank 1b to the at least one reservoir 1a the pressurisation system 3 may comprise a flow control valve 34 in the pressurisation system 3.

The control valve 34 can be integrated in a duct 32 or preferably in the return line 31.

The control valve 34 can be integrated in a duct 32 or preferably in the return line 31.

It is adapted to control the fluid flow only if the filling gas pressure upstream of the control valve 34 and therefore in the tank 1b is higher than the filling gas pressure downstream of the control valve 34 and therefore in the reservoir 1a.

In order to control the opening and/or closing of the control valve 34, the pressurisation system 3 may comprise a first sensor 35 adapted to measure the filling gas pressure upstream of the control valve 34; a second sensor 36 adapted to measure the filling gas pressure downstream of the control valve 34.

The control valve 34 is therefore only adapted to control the passage of fluid if the pressure measured by the first sensor 35 is greater than the pressure measured by the second sensor 36.

The refuelling device 1 may comprise a control unit for the operation of the device 1 described below.

It is adapted to control at least one regulating valve 28 and/or at least one pump 23 preferably according to the data collected by pressure gauge 26 and/or pressure meter 27 as described above.

The control unit is also adapted to control the control valve 34 according to the pressure in the reservoir 1a and/or in the tank 1b.

It comprises a PLC.

The invention comprises a new refuelling method for supplying liquefied gases preferably implemented through the refuelling device 1 described above.

This method describes the operation of the refuelling device 1.

The refuelling process is adapted to refuel at least one tank 1b (suitably one or two tanks 1b) using at least one reservoir 1a and preferably using several reservoirs 1a in parallel, simultaneously.

The refuelling process provides a refuelling step and a pressurization step.

Advantageously, the refuelling method requires that the refuelling and pressurisation steps are carried out simultaneously so that the filling gas counteracts the lowering of pressure in reservoir 1a.

During the refuelling step, the liquefied gas is transferred from said reservoir 1a to said tank 1b. In detail, the at least one pump 25 controls the exit from said reservoir 1a of the liquefied gas which thus passes through the withdrawal duct 21, the inlet duct 22 and enters the tank 1b.

This withdrawal of liquefied gas causes a lowering of the pressure of the reservoir 1a.

Simultaneously, the pressurization step takes place.

This pressurisation step takes place only if between reservoirs 1a and tanks 1b meeting the requirement of having the pressure in at least one tank 1b greater than that in at least one reservoir 1a.

In the pressurization step, the pressurization system 3 works by counteracting the lowering of the pressure in the reservoir 1a due to the withdrawal of liquefied gas. During the pressurisation step, a filling gas (preferably the boil-off in the at least one tank 1b) is introduced into the reservoir 1a.

At this step, the filling gas, driven by a compressor or preferably only controlled by said lowering of the pressure in reservoir 1a, passes through the pressurization system 3 to enter the reservoir 1a by counteracting the lowering of the pressure and preferably maintaining the pressure of the reservoir 1a substantially constant, despite the withdrawal of liquefied gas.

Advantageously, the filling gas is the boil-off which, through the pressurisation system 3, passes from the one or more tanks 1b to one or more reservoirs 1a.

The refuelling method for supplying liquefied gases is preferably adapted to refuel a tank 1b using several reservoirs 1a in parallel at the same time.

In this case, during the refuelling step, the liquefied gas is simultaneously withdrawn from all reservoirs 1a and transferred to the tank 1b; and during the pressurisation step, the filling gas (preferably the boil-off in tank 1b) is simultaneously introduced into all reservoirs 1a.

In particular, during the filling step, at least one pump 25 withdraws simultaneously a liquefied gas flow from all reservoirs 1a. Each flow of liquefied gases passes through a withdrawal duct 21 and reaches the collection manifold 23 where it joins the other flows, forming a single flow that enters the tank 1b through the inlet duct 22.

In detail, the liquefied gas flows exiting the reservoirs 1a are all identical.

The withdrawal step is carried out at the same time as the filling phase in which the pressures of the reservoirs 1a are made uniform and therefore they are made/kept substantially equal to each other.

Preferably during the filling step the filling gas (preferably the boil-off of the tank 1b) passes through the return line 31, divides in the connecting member 33 in sub-flows suitably equal to each other. Each sub-flow passes through a duct 32 thereby entering a reservoir 1a.

It should be noted that the reservoirs 1a show pressures which are almost equal to each other, since they all simultaneously placed in a fluidic through connection.

The refuelling method and device 1 according to the invention achieve some important advantages.

In fact, they allow to use simultaneously more reservoirs 1a, without complex and laborious devices, and therefore in parallel.

This aspect is increased by the possibility of regulating the flow according to the inlet and preferably outlet pressure, thus adapting the working conditions of the pump 4 to those of the liquefied gas flow. More in particular, it is obtained by keeping the difference between outlet and inlet pressure substantially constant. This aspect is also achievable thanks to the possibility to maintain the pressures of said reservoirs 1a substantially equal to each other and in particular constant.

In particular, this solution is made possible by using the boil-off of the tank 1b (currently dispersed by combustion in the environment) and then by creating, through the pressurization system 3, a second fluidic through connection (in particular, gas) between reservoirs 1a and tank 1b which can be exploited to have a flow working in parallel and counteracting the withdrawal of liquefied gas from the reservoir 1a.

In conclusion, the refuelling method and the device 1 allow the working conditions of the different reservoirs 1a to be uniform, thus making it extremely simple and inexpensive to control the flow of liquefied gas and therefore the one or more pumps 25.

This uniformity of the reservoirs 1a is ensured throughout the entire refuelling process.

The invention is subject to variations without departing from the scope of the inventive concept as defined in the claims. All details may be replaced with equivalent elements and the scope of the invention includes all other materials, shapes and dimensions.

1. A refuelling device for supplying liquefied gases, comprising
a feed system adapted to place a plurality of refuelling reservoirs in fluidic through connection with at least one tank;
wherein said feed system comprises
withdrawal ducts, each of which is adapted to withdraw said liquefied gas from one of said reservoirs;
an inlet duct for introducing said liquefied gas into said tank;
a collection manifold adapted to convey said liquefied gas from said withdrawal ducts, and therefore from said reservoirs, into said inlet duct;
at least one pump adapted to move said liquefied gas in said feed system, thus allowing said liquefied gas to be simultaneously withdrawn from each of said reservoirs;
for each pump, a pressure gauge adapted to measure the inlet pressure of said liquefied gas entering said pump and a pressure meter adapted to measure the outlet pressure of said liquefied gas exiting said pump; and
a regulating valve for adjusting the flow in said inlet duct according to the difference between said inlet pressure and said outlet pressure.

2. The refuelling device according to claim 1, comprising a pressurization system comprising a connecting member adapted to place the reservoirs in reciprocal fluidic through connection so as to place said reservoirs under the same pressure.

3. The refuelling device according to claim 2, wherein said pressurization system is adapted to place said tank in fluidic through connection with each of said tanks, thus allowing the boil-off of said liquefied gas in said tank to be introduced into each of said reservoirs, thereby raising the pressure of said reservoirs.

4. The refuelling device according to claim 3, wherein said pressurization system is devoid of compressors for controlling the passage of said boil-off from said tank to said reservoirs.

5. The refuelling device according to claim 1, wherein said pressure meter is adapted to measure the outlet pressure by measuring said pressure of said liquefied gas in said inlet duct.

6. The refuelling device according to claim 1, wherein said feed system comprises a plurality of said at least one pump, each adapted to move said liquefied gas in one of said withdrawal ducts, and a plurality of pressure gauges, each located upstream of one of said pumps.

7. The refuelling device according to claim 5, wherein said feed system comprises a plurality of pressure meters, each located downstream of one of said pumps.

8. A refuelling method for supplying liquefied gases, which is adapted to refuel at least one tank by using at least one reservoir containing said liquefied gas; said refuelling method comprising
a filling step, wherein said liquefied gas is transferred from said reservoir to said tank;
a pressurizing step for pressurizing said reservoir, wherein the boil-off of said liquefied gas in said tank is introduced into said reservoir; and
in that
said filling step and said pressurization step are carried out simultaneously, so that said boil-off counteracts the lowering of the pressure in said reservoir caused by said filling step.

9. The refuelling method for supplying liquefied gases according to claim 8, which uses a plurality of said at least one reservoir; and wherein in said filling step said liquefied gas is transferred from said reservoirs to said tank; and wherein in said pressurization step said boil-off of said liquefied gas in said tank is introduced into said reservoirs, thus minimizing refueling times.

10. The refuelling device according to claim 6, wherein said feed system comprises a plurality of pressure meters, each located downstream of one of said pumps.

11. The refuelling device according to claim 2, wherein said pressure meter is adapted to measure the outlet pressure by measuring said pressure of said liquefied gas in said inlet duct.

12. The refuelling device according to claim 2, wherein said feed system comprises a plurality of said at least one pump, each adapted to move said liquefied gas in one of said withdrawal ducts, and a plurality of pressure gauges, each located upstream of one of said pumps.

13. The refuelling device according to claim 11, wherein said feed system comprises a plurality of pressure meters, each located downstream of one of said pumps.

14. The refuelling device according to claim 12, wherein said feed system comprises a plurality of pressure meters, each located downstream of one of said pumps.
